(19) United States
(12) Patent Application Publication
(10) Pub. No.: US 2026/0113081 A1
(43) Pub. Date: Apr. 23, 2026

(54) DYNAMIC ENDPOINT DEVICE GROUPING FOR MULTI-USER-MULTIPLE INPUT-MULTIPLE OUTPUT-BASED WIRELESS NETWORK COMMUNICATIONS

(71) Applicant: AT&T Intellectual Property I, L.P., Atlanta, GA (US)

(72) Inventors: Hongyan Lei, Plano, TX (US); Yupeng Jia, South Pasadena, CA (US); Venson Shaw, Kirkland, WA (US)

(21) Appl. No.: 18/919,304

(22) Filed: Oct. 17, 2024

(51) Int. Cl. H04B 7/0452; H04W 64/00

(52) U.S. Cl. CPC H04B 7/0452; H04W 64/006

(57) ABSTRACT

A processing system including at least one processor deployed in a wireless network may track a plurality of characteristics associated with a plurality of endpoint devices in a coverage area of the wireless network, where the plurality of characteristics includes endpoint device trajectories for the plurality of endpoint devices. The processing system may next detect a correspondence of the plurality of characteristics associated with the plurality of endpoint devices, where the detecting of the correspondence of the plurality of characteristics is based upon at least the endpoint device trajectories. In addition, processing system may assign the plurality of endpoint devices to a multi-user group based upon the detecting of the correspondence of the plurality of characteristics associated with the plurality of endpoint devices. The processing system may then transmit via a multi-user multiple input-multiple output shared channel respective data streams to the plurality of endpoint devices in the multi-user group.

### BACKGROUND

The present disclosure relates generally to wireless networks, and more particularly to methods, non-transitory computer-readable media, and apparatuses for transmitting via a multi-user multiple input-multiple output shared channel respective data streams to a plurality of endpoint devices in a multi-user group formed based on a correspondence of characteristics of the plurality of endpoint devices including endpoint device trajectories.

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network.

### SUMMARY

In one example, the present disclosure discloses a method, computer-readable medium, and apparatus for transmitting via a multi-user multiple input-multiple output shared channel respective data streams to a plurality of endpoint devices in a multi-user group formed based on a correspondence of characteristics of the plurality of endpoint devices including endpoint device trajectories. For example, a processing system including at least one processor deployed in a wireless network may track a plurality of characteristics associated with a plurality of endpoint devices in a coverage area of the wireless network, where the plurality of characteristics includes endpoint device trajectories for the plurality of endpoint devices. The processing system may next detect a correspondence of the plurality of characteristics associated with the plurality of endpoint devices, where the detecting of the correspondence of the plurality of characteristics is based upon at least the endpoint device trajectories. In addition, processing system may assign the plurality of endpoint devices to a multi-user group based upon the detecting of the correspondence of the plurality of characteristics associated with the plurality of endpoint devices. The processing system may then transmit via a multi-user multiple input-multiple output shared channel respective data streams to the plurality of endpoint devices in the multi-user group.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for transmitting via a multi-user multiple input-multiple output shared channel respective data streams to a plurality of endpoint devices in a multi-user group formed based on a correspondence of characteristics of the plurality of endpoint devices including endpoint device trajectories; and

FIG. 3 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for transmitting via a multi-user multiple input-multiple output shared channel respective data streams to a plurality of endpoint devices in a multi-user group formed based on a correspondence of characteristics of the plurality of endpoint devices including endpoint device trajectories. In particular, multi-user-multiple input-multiple output (MU-MIMO) is a technology that affords higher speed, higher capacity, better spectral efficiency, and better user experience in a wireless network. Single-user MIMO (SU-MIMO) improves single user throughput, while MU-MIMO increases network capacity by scheduling multiple-users on the same radio channel, via spatial separation of the users. However, MU-MIMO is generally limited to stationary endpoint devices.

Examples of the present disclosure describe techniques for endpoint device grouping that allows MU-MIMO to be utilized for groups of non-stationary endpoint devices (e.g., in addition to serving stationary endpoint devices as presently supported). In a mobility environment, endpoint devices may keep moving. Accordingly, in one example, the present disclosure may apply real-time adjustments of an endpoint device MU-MIMO grouping, or groupings. In one example, the present disclosure may include an artificial intelligence (AI) and/or machine learning (ML)-based module to predict endpoint device trajectories and/or to select endpoint device MU-MIMO groupings. In one example, the AI/ML module may also dynamically adjust group membership based on network conditions, endpoint device movements, and endpoint device data traffic patterns. In one example, the present disclosure may further include AI/ML-based adjustment of endpoint device grouping criteria, e.g., based upon one or more performance metrics, e.g., key performance indicators (KPIs) or the like. In one example, aspects of the present disclosure may operate within an open radio access network O-RAN) open fronthaul (between radio and baseband) interface to enhance MU-MIMO performance. For instance, an O-RAN open fronthaul architecture may enable intelligent MU-MIMO O-RU (radio unit) and O-DU (distributed unit) vendor mix-and-match to drive innovation and increase competition, which may result in better MU-MIMO performance and flexibility in the long term.

It should be noted that the performance benefits of MU-MIMO may depend on the selection and pairing of the multiple endpoint devices. A good grouping algorithm can significantly increase network capacity and network spectral utilization. On the other hand, an inefficient grouping algorithm may result in unnecessary interference and may degrade the network performance. At a given cell, there may be numerous endpoint devices to serve. A radio access network (RAN) scheduler of the base station, e.g., of a baseband unit (BBU), centralized unit (CU), distributed unit (DU), or the like, may group endpoint devices for MU-MIMO. In one example, the scheduler may group endpoint devices with similar characteristics, where the similar characteristics may include similar trajectories of movement. However, it should be noted that for MU-MIMO grouping, the scheduler may still be configured to place stationary or relatively stationary endpoint devices into a same group or groups. In one example, the groupings may further be based upon similarity of conditions experienced by endpoint devices in the wireless environment (e.g., similarity of radio frequency (RF) conditions) to maximize the spectrum efficiency. For instance, in one example, stationary endpoint devices with good RF conditions may be grouped, and may be assigned to utilize 4-layer MU-MIMO for best performance. On the other hand, stationary endpoint devices in mid-RF conditions may be assigned to a group and may obtain better performance with 2-layer MU-MIMO. In addition, endpoint devices in motion with similar trajectories (e.g., directions of movement, or directions of movement and speed (e.g., similar velocities)) may be grouped to facilitate similar scheduling, similar collection of endpoint device channel state reporting, and so forth.

In one example, the scheduler may be configured to apply “stickiness” to MU-MIMO endpoint device groupings, which may reduce control plane utilization and increase the spectrum efficiency for user traffic. For instance, endpoint devices may be grouped together when the endpoint devices have similar trajectories and RF conditions, e.g., according to a set of one or more thresholds for one or more similarity metrics and/or according to an AI/ML module configuration. However, once the endpoint devices are assigned to a group, less stringent criteria may be applied to determine whether an endpoint device remains within the group. For instance, a trajectory of an endpoint device may have a threshold dissimilarity to others in the group before being removed from the group. In other words, a hysteresis may be applied to the grouping and ungrouping criteria to avoid frequent re-groupings. For instance, by selecting thresholds to prevent premature removal of an endpoint device from a group, this may reduce physical downlink control channel (PDCCH) and air-interface control-plane overhead.

Notably, one of the challenges for MU-MIMO implementation is the increased demand for control-plane capacity such as physical downlink control channel (PDCCH). Since multiple endpoint devices are to be scheduled using the same resources, the PDCCH may become a bottleneck of the scheduling—even if there are still resources such as physical resource blocks (PRBs) remaining for user plane traffic. MU-MIMO grouping stickiness allows pre-scheduling of the same resources to the same endpoint device groups for several transmission time intervals (TTIs), thus reducing the demand for PDCCH resources. In addition, MU-MIMO stickiness allows the RAN scheduler to group the user equipment (UE) channel state reporting and reduce the periodicity of the UE channel state report over the air-interface, thus reducing the air interface control plane overhead and increasing the spectrum efficiency for user traffic.

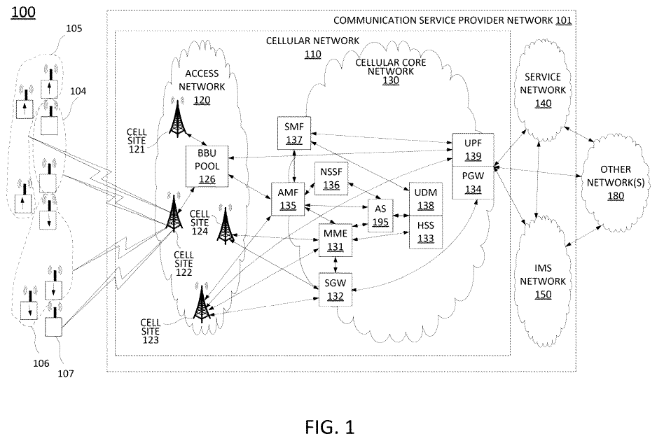

In one example, the present disclosure may adjust the thresholds for grouping based on one or more performance metrics (e.g., key performance indicators (KPIs)). For instance, in one example, the present disclosure may model endpoint device grouping patterns and may then use one or more machine learning models (MLMs) to find the optimal endpoint device grouping patterns. The MLM-derived patterns may then be applied to new configurations. When radio environment conditions and network loading change, the criteria for optimal endpoint device groupings may also change. Thus, a machine learning-based process may suggest new thresholds for application of the groupings. As such, examples of the present disclosure improve MU-MIMO utilization via optimization of endpoint device groupings. In particular, scheduling may be based on the group characteristics to improve both overall spectrum efficiency and individual endpoint device experience. These and other aspects of the present disclosure are discussed in greater detail below in connection with the examples of FIGS. 1-3.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 5G/4G/Long Term Evolution (LTE) hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the progression of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, the base stations may have a distributed architecture comprising centralized units (CUs) (e.g., represented by BBU pool 126) and associated distributed units (DUs) (e.g., represented by BBU pool 126 and/or deployed at cell sites 121 and 122) and radio units (RUs) (e.g., deployed at cell sites 121 and 122). In one example, these components may be in accordance with an O-RAN architecture, e.g., an Open-CU (O-CU), an Open-DU (O-DU), an Open-RU (O-RU), or the like.

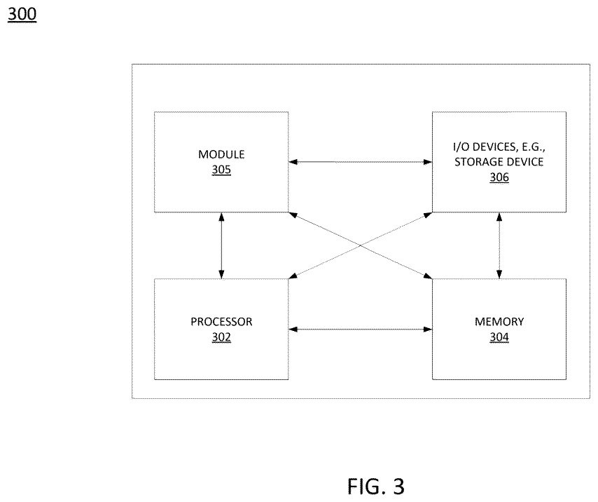

In accordance with the present disclosure, any one or more of cell sites 121-123 may be deployed with antenna and radio infrastructures, including multiple input multiple output (MIMO) capable radios, millimeter wave antennas, and so forth. Furthermore, in accordance with the present disclosure, a base station (e.g., cell sites 121-123 and/or baseband units within BBU pool 126) may comprise all or a portion of a computing system, such as computing system 300 as depicted in FIG. 3, and may be configured to provide one or more functions in connection with examples of the present disclosure for transmitting via a multi-user multiple input-multiple output shared channel respective data streams to a plurality of endpoint devices in a multi-user group formed based of a correspondence of characteristics of the plurality of endpoint devices including endpoint device trajectories. For instance, an O-DU may include a RAN scheduler (e.g., a new radio (NR) scheduler), which may assign endpoint devices to respective MU-MIMO groups.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

FIG. 1 also illustrates various endpoint devices (or groupings of endpoint devices) 104-107, e.g., user equipment (UEs). Endpoint devices (or groupings of endpoint devices) 104-107 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, endpoint devices 104-107 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Some or all of the endpoint devices 104-107 may also include a gyroscope and compass to determine orientation(s), a global positioning system (GPS) receiver for determining a location (e.g., in latitude and longitude, or the like), and so forth. In one example, some or all of the endpoint devices 104-107 may include a built-in/embedded barometer from which measurements may be taken and from which an altitude or elevation of the respective endpoint device may be determined. In one example, some or all of the endpoint devices 104-107 may also be configured to determine location/position from near field communication (NFC) technologies, such as Wi-Fi direct and/or other IEEE 802.11 communications or sensing (e.g., in relation to beacons or reference points in an environment), IEEE 802.15 based communications or sensing (e.g., “Bluetooth”, “ZigBee”, etc.), and so forth. In addition, in one example, each of the endpoint devices 104-107 may comprise all or a portion of a computing system, such as computing system 300 depicted in FIG. 3, and may be configured to perform one or more steps, functions, and/or operations in connection with examples of the present disclosure for transmitting via a multi-user multiple input-multiple output shared channel respective data streams to a plurality of endpoint devices in a multi-user group formed based on a correspondence of characteristics of the plurality of endpoint devices including endpoint device trajectories.

As illustrated in FIG. 1, endpoint devices 104-107 may register and attach to cell site 122 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the cell site 122 and establish a radio resource control (RRC) communication, transmitting a registration/attach request, performing authentication procedures, establishing a default protocol data unit (PDU) session, e.g., including bearer assignment, and so forth.

In accordance with the present disclosure, endpoint devices (e.g., sessions and/or bearers associated therewith) may be assigned to physical resources of an air interface by the RAN scheduler, e.g., a component of BBU pool 126 (such as a DU, or O-DU, or the like). In one example, some or all of a frequency-time resource grid (e.g., a set of resource elements, a physical resource block (PRB), a bandwidth part or the like) may be shared by different endpoint devices in a MU-MIMO group. In other words, the resource grid may comprise a shared channel, where resources elements (and/or PRBs) that may have previously been assigned to individual endpoint devices or sessions may instead be shared by multiple endpoint devices with spatial diversity.

In accordance with the present disclosure, the RAN scheduler may group endpoint devices into MU-MIMO groups according to several criteria. First, stationary or relatively stationary endpoint devices may be assigned to a MU-MIMO group. For instance, endpoint devices 104 may represent such a group. In one example, distance limits may be applied to the grouping such that stationary endpoint devices that are relatively close to each other may be grouped, while those that are too far away may be excluded or assigned to another group. In one example, stationary endpoint device groupings may be further segregated by RF or other conditions experienced by the different endpoint devices. In this regard, the example of FIG. 1 illustrates endpoint device 107 in a group by itself. For example, endpoint device 107 may be beyond a threshold distance (linear or angular, etc.) from other stationary endpoint devices 104 and/or may experience RF conditions that are sufficiently different from endpoint devices 104.

Next, non-stationary endpoint devices with similar trajectories may be grouped together. In one example, MU-MIMO groupings may be further refined by similarity of RF conditions experienced by the respective endpoint devices. For instance, in the example of FIG. 1, endpoint devices 105 may have similar trajectories (e.g., indicated by arrow overlays on the respective endpoint devices 105) and/or RF conditions, while endpoint devices 106 may have similar trajectories (e.g., indicated by arrow overlays on the respective endpoint devices 106) and/or RF conditions. As such, the RAN scheduler may exploit commonalities of the respective endpoint devices within a group to maximize the spectrum efficiency. Cell site 122 may then transmit respective data streams, e.g., user data, to respective endpoint devices within a same group (via a MU-MIMO shared channel comprising shared resource elements, PRBs, or the like of a frequency-time resource grid). In one example, the transmission via a MU-MIMO shared channel may be optimized for the characteristics of the particular group. For instance, as noted above, stationary endpoint devices with good RF conditions (e.g., endpoint devices 104) may be grouped, and may be assigned to utilize 4-layer MU-MIMO for best performance. On the other hand, stationary endpoint devices in mid-RF conditions may be assigned to a group and may obtain better performance with 2-layer MU-MIMO. Other groups, such as endpoint devices 105, endpoint devices 106, etc., may be best served via 8-layers, 16-layers, and so forth.

These grouping criteria may further enable the RAN scheduler to reduce physical downlink control channel (PDCCH) and air-interface control-plane overhead. For instance, intelligent MU-MIMO grouping allows pre-scheduling of the same resources to the same endpoint device groups for several transmission time intervals (TTIs), thus reducing the demand for PDCCH resources (or other resources such as PDSCH resources, etc.). Similarly, intelligent MU-MIMO may enable the periodicity of the UE channel state report over the air-interface to be reduced, thus reducing the air interface control plane overhead and increasing the spectrum efficiency for user traffic. For instance, groups may last longer and/or endpoint devices may remain within groups longer using the selection/grouping criteria. As noted above, further gains may be achieved by applying stickiness/hysteresis to the grouping/ungrouping criteria to avoid more frequent group dropping/switching. As also noted above, in one example, the groupings may be made via one or more AI/ML techniques, such as via a clustering algorithm or the like.

It should be noted that the example of FIG. 1 illustrates the various endpoint devices 104-107 attached to cell site 122. However, as various endpoint devices move throughout an environment (e.g., endpoint devices 105 and 106), individual endpoint devices or MU-MIMO groups may engage in handoff procedures to attach to one or more other cell sites. For instance, a centroid of endpoint devices 105 may eventually move closer to cell site 121 such that collective performance gains may be achieved by switching from cell site 122 to cell site 121. Similarly, a centroid of endpoint devices 106 may move closer to cell site 123 such that collective performance gains may be achieved by switching from cell site 122 to cell site 123. It should also be noted that although the foregoing describes MU-MIMO groupings, it should be understood that such techniques may operate alongside and/or in conjunction with single user (SU)-MIMO and/or non-MIMO communications. For instance, other endpoint devices may be incapable of MIMO-based communications. Alternatively, or in addition, endpoint devices may lack sufficient separation distance such that lack of spatial diversity prevents superior performance from being achieved through MU-MIMO.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between MME 131, SGW 132, cell sites 121-124, PGW 134, AMF 135, NSSF 136, SMF 137, UDM 138, and/or UPF 139, and other components of system 100 are omitted for clarity, such as additional routers, switches, gateways, and the like. Alternatively, or in addition, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), a RAN intelligent controller (RIC), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. For instance, in various examples, the present disclosure may further include the use of an inter-radio access technology (inter-RAT) air interface, e.g., with primary and secondary cell groups and/or split bearers or the like. Thus, these and other modifications are all contemplated within the scope of the present disclosure.

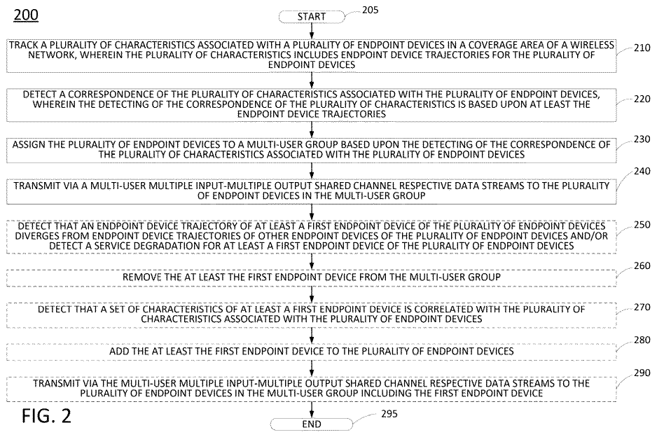

FIG. 2 illustrates a flowchart of an example method 200 for transmitting via a multi-user multiple input-multiple output shared channel respective data streams to a plurality of endpoint devices in a multi-user group formed based on a correspondence of characteristics of the plurality of endpoint devices including endpoint device trajectories, in accordance with the present disclosure. In one example, steps, functions and/or operations of the method 200 may be performed by a device as illustrated in FIG. 1, e.g., a processing system comprising a base station, a BBU, a CU, a DU, a scheduler, etc., or collectively via a plurality devices in FIG. 1, such as a base station, a BBU, a CU, a DU, a scheduler, etc., in conjunction with a different one of such components and/or any one or more other components in FIG. 1. In one example, the steps, functions, or operations of method 200 may be performed by a computing device or system 300, and/or a processing system 302 as described in connection with FIG. 3 below. For instance, the computing device or system 300 may represent at least a portion of device or system deployed in a cellular network that is configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system, such as processing system 302. The method 200 begins in step 205 and proceeds to step 210.

At step 210, the processing system (e.g., deployed in a wireless/cellular network and comprising: a base station, a BBU, a CU, a DU, a scheduler, or the like) tracks a plurality of characteristics associated with a plurality of endpoint devices in a coverage area of the wireless network, where the plurality of characteristics includes endpoint device trajectories for the plurality of endpoint devices. For instance, the coverage area may be within communication range of one or more cell sites (e.g., sufficient to detect PSS, SSS, PBCH, DMRS, or the like and/or to engaging a random access channel to report to a cell site, etc.), within a tracking area, etc. The endpoint device trajectories may comprise direction of movement, velocity, and/or acceleration (e.g., a respective direction of movement for each of the plurality of endpoint devices). As noted above, in one example, the endpoint device trajectories may further comprise speeds of movement. In other words, the trajectories may comprise velocities, or a sequence of velocities and/or positions (which can indicate direction of movement and/or speed). In one example, the plurality of characteristics may further include radio environment characteristics (e.g., a respective radio environment characteristic (or a respective set of radio environment characteristics) for each of the plurality of endpoint devices). In one example, the endpoint device trajectories may comprise predicted trajectories, e.g., a sequence of positions and/or velocities. For example, in one example, the forecast may be a formulaic prediction based on linear projection or curve fitting of past positions and/or velocities. In another example, the predicted trajectories can be predicted/forecast via a machine learning model, such as a time series prediction model or the like, e.g., using data of an individual endpoint device to generate a predicted trajectory for that endpoint device, and/or based on historical data of other endpoint devices in an area. For example, this can include learning that most endpoint devices may funnel through a passage between buildings or terrain features, and so forth. In another example, the “prediction” of trajectories may be obtained in a machine learning process at step 220 in which past trajectories may be correlated to suggest that forecast trajectories may be sufficiently similar (e.g., meeting a similarity metric) such the endpoint devices are grouped together for MU-MIMO.

At step 220, the processing system detects a correspondence of the plurality of characteristics associated with the plurality of endpoint devices, where the detecting of the correspondence of the plurality of characteristics is based upon at least the endpoint device trajectories. For instance, in one example, step 220 may include detecting that respective sets of characteristics of different endpoint devices of the plurality of endpoint devices have a similarity metric that is above or below a threshold (or broadly meeting a threshold). For instance, each set of characteristics may comprise or may be represented as a vector in a multi-dimensional feature space in which a similarity metric may be measured. For instance, the similarly metric may comprise a threshold distance in the feature space, or the like. In other words, “correspondence” can be a sufficient similarity (e.g., exceeding a threshold similarity metric, or the like) among the endpoint device trajectories, or the endpoint device trajectories plus other characteristics, such as radio environment characteristics/conditions, etc. In one example, the detecting of the correspondence of the plurality of characteristics may be via a machine learning model that is configured to process sets of characteristics of a set of endpoint devices including the plurality of endpoint devices and to output the assigning of the plurality of endpoint devices to one or more multi-user groups. For instance, the MLM may be configured/trained according to an objective function to maximize a similarity among the plurality of endpoint devices assigned to the multi-user group. For instance, the “similarity” metric may be included in the objective function. The objective function may be defined by a network operator, or may be learned and evolve over time based upon an objective criteria, e.g., one or more performance indicators, such as increased throughput, bandwidth efficiency, etc. and/or a combination of performance indicators, e.g., a weighted combination of performance indicators. To illustrate, the similarity metric may be based upon a clustering algorithm/technique, e.g., an AI/ML model, where the plurality of endpoint devices are assigned to the same cluster. In one example, step 220 may include detecting correspondence among other endpoint devices, e.g., according to the same or similar factors (and/or dissimilarity from the plurality of endpoint devices).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), a clustering algorithm (such as k-means clustering or variants thereof (e.g., partitioning around medioids (PAM), k-medioid, etc.), density-based spatial clustering of applications with noise (DBSCAN), etc.), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

At step 230, the processing system assigns the plurality of endpoint devices to a multi-user group (e.g., a MU-MIMO scheduling group) based upon the detecting of the correspondence of the plurality of characteristics associated with the plurality of endpoint devices. For instance, the plurality of endpoint devices may be grouped when the similarity metric among the devices meets a designated threshold, when the plurality of endpoint devices are clustered into a same cluster according to a clustering algorithm, and/or when a machine learning model output indicates that the plurality of endpoint devices meet a similarity criterion or otherwise should be matched/grouped. In one example, step 230 may include assigning other endpoint devices to one or more other scheduling groups, e.g., according to the same or similar factors. In one example, step 230 may include splitting endpoint devices having similar characteristics into smaller groups. For instance, there may be a large number of endpoint devices with similar trajectories and/other characteristics. However, if RF conditions are relatively poor for these devices it may be beneficial to use fewer layers for transmission at step 240, and hence smaller groups may be warranted.

At step 240, the processing system transmits, via a multi-user multiple input-multiple output shared channel, respective data streams to the plurality of endpoint devices in the multi-user group. For instance, the shared channel may comprise some or all of a frequency-time resource grid, e.g., a set of resource elements, a physical resource block (PRB), a bandwidth part or the like, which may be shared by the endpoint devices in a MU-MIMO group. It should be noted that the endpoint devices may have similar characteristics in terms of trajectories and/or RF conditions. However, for maximum benefit from MU-MIMO, the endpoint devices in the same group using the shared resources preferably have sufficient spatial diversity to minimize interference. In one example, step 240 may include optimizing transmission parameters, such as the number of layers, the resource elements and/or PRBs assigned, etc. based on the group characteristics, such as distance from the transmit array, direction of movement, quality of RF conditions, etc.

At optional step 250, the processing system may (1) detect that an endpoint device trajectory of at least a first endpoint device of the plurality of endpoint devices diverges from endpoint device trajectories of other endpoint devices of the plurality of endpoint devices and/or (2) detect a service degradation for at least a first endpoint device of the plurality of endpoint devices. For instance, optional step 250 may include detecting that a divergence is more than a threshold divergence according to a divergence metric (e.g., too far away in distance from the others, such as a centroid of the group and/or angular view from the cell site/base station, RRH, antenna array, etc.). The divergence can be an actual observed divergence or predicted divergence, e.g., calculated from predicted endpoint device trajectories, or the like. In addition, the degradation may be indicated by one or more observed conditions relating to one or more performance indicators (e.g., KPIs), such as a signal to noise ratio (SNR) or signal to interference and noise ratio (SINR), a throughput, a packet loss rate, a retransmission rate, etc.

At optional step 260, the processing system may remove the at least the first endpoint device from the multi-user group, e.g., in response to the detecting of one or both conditions at optional step 250. In one example, the removing may include transmitting user data to the at least the first endpoint device via a channel that is different from the multi-user multiple input-multiple output shared channel that is used for the plurality of endpoint devices excluding the at least the first endpoint device. For instance, the at least the first endpoint device can be assigned to a different MU-MIMO group or can be served via SU-MIMO on a different channel (e.g., a different set of physical resources on the same or a different set of sub-carrier frequencies).

At optional step 270, the processing system may detect that a set of characteristics of at least a first endpoint device is correlated with the plurality of characteristics associated with the plurality of endpoint devices. For instance, the endpoint device trajectory of the at least the first endpoint device may have sufficient correlation to the endpoint device trajectories of the plurality of endpoint devices. This can be determined via any of the techniques described above, such as in accordance with a distance metric in a feature space, via a clustering algorithm, via machine learning, and so forth. In one example, optional step 270 may comprise the same or similar operations as step 220 discussed above.

At optional step 280, the processing system may add the at least the first endpoint device to the plurality of endpoint devices. For instance, the at least the first endpoint device may be added to the multi-user group. In one example, optional step 280 may comprise the same or similar operations as step 230 discussed above.

At optional step 290, the processing system may transmit via the multi-user multiple input-multiple output shared channel respective data streams to the plurality of endpoint devices in the multi-user group including the first endpoint device. For instance, optional step 290 may comprise the same or similar operations as step 240, but with an additional endpoint device included in the multi-user group (e.g., a MU-MIMO scheduling group) using the multi-user multiple input-multiple output shared channel.

Following step 240, or any of the optional steps 250-290, the method 200 proceeds to step 295 where the method 200 ends.

It should be noted that the method 200 may be expanded to include additional steps or may be modified to include additional operations with respect to the steps outlined above. For example, the method 200 may be repeated on an ongoing basis to form endpoint device groups for MU-MIMO (e.g., where the endpoint devices comprising respective groups can change, where endpoint devices may sometimes be assigned to a MU-MIMO group and at other times may be unassigned to a MU-MIMO group (e.g., to be served via SU-MIMO and/or non-MIMO resources)). In one example, optional steps 250-290 may alternatively or additionally comprise repetitions of steps 210-240. In one example, the method 200 may be expanded to further include uplink MU-MIMO shared resource scheduling and transmission by the plurality of endpoint devices in the multi-user group. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for transmitting via a multi-user multiple input-multiple output shared channel respective data streams to a plurality of endpoint devices in a multi-user group formed based of a correspondence of characteristics of the plurality of endpoint devices including endpoint device trajectories, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 306 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for transmitting via a multi-user multiple input-multiple output shared channel respective data streams to a plurality of endpoint devices in a multi-user group formed based on a correspondence of characteristics of the plurality of endpoint devices including endpoint device trajectories (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for transmitting via a multi-user multiple input-multiple output shared channel respective data streams to a plurality of endpoint devices in a multi-user group formed based on a correspondence of characteristics of the plurality of endpoint devices including endpoint device trajectories (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
tracking, by a processing system including at least one processor deployed in a wireless network, a plurality of characteristics associated with a plurality of endpoint devices in a coverage area of the wireless network, wherein the plurality of characteristics includes endpoint device trajectories for the plurality of endpoint devices;
detecting, by the processing system, a correspondence of the plurality of characteristics associated with the plurality of endpoint devices, wherein the detecting of the correspondence of the plurality of characteristics is based upon at least the endpoint device trajectories;
assigning, by the processing system, the plurality of endpoint devices to a multi-user group based upon the detecting of the correspondence of the plurality of characteristics associated with the plurality of endpoint devices; and
transmitting, by the processing system, via a multi-user multiple input-multiple output shared channel respective data streams to the plurality of endpoint devices in the multi-user group.

2. The method of claim 1, wherein the endpoint device trajectories comprise directions of movement of the plurality of endpoint devices.

3. The method of claim 2, wherein the endpoint device trajectories further comprise speeds of movement of the plurality of endpoint devices.

4. The method of claim 1, wherein the plurality of characteristics further includes radio environment characteristics.

5. The method of claim 4, wherein the detecting of the correspondence of the plurality of characteristics includes detecting that respective sets of characteristics of different endpoint devices of the plurality of endpoint devices have a similarity metric that meets a threshold.

6. The method of claim 1, wherein the detecting of the correspondence of the plurality of characteristics is via a machine learning model that is configured to process sets of characteristics of a set of endpoint devices including the plurality of endpoint devices and to output the assigning of the plurality of endpoint devices to the multi-user group.

7. The method of claim 1, wherein the endpoint device trajectories comprise predicted trajectories of the plurality of endpoint devices.

8. The method of claim 1, further comprising:
detecting that an endpoint device trajectory of at least a first endpoint device of the plurality of endpoint devices diverges from endpoint device trajectories of other endpoint devices of the plurality of endpoint devices; and
removing the at least the first endpoint device from the multi-user group.

9. The method of claim 8, wherein the removing includes transmitting user data to the at least the first endpoint device via a channel that is different from the multi-user multiple input-multiple output shared channel that is used for the plurality of endpoint devices excluding the at least the first endpoint device.

10. The method of claim 1, further comprising:
detecting a service degradation for at least a first endpoint device of the plurality of endpoint devices; and
removing the at least the first endpoint device from the multi-user group.

11. The method of claim 1, further comprising:
detecting that a set of characteristics of at least a first endpoint device is correlated with the plurality of characteristics associated with the plurality of endpoint devices; and
adding the at least the first endpoint device to the multi-user group.

12. A non-transitory computer-readable medium storing instructions which, when executed by a processing system including at least one processor deployed in a wireless network, cause the processing system to perform operations, the operations comprising:
tracking a plurality of characteristics associated with a plurality of endpoint devices in a coverage area of the wireless network, wherein the plurality of characteristics includes endpoint device trajectories for the plurality of endpoint devices;
detecting a correspondence of the plurality of characteristics associated with the plurality of endpoint devices, wherein the detecting of the correspondence of the plurality of characteristics is based upon at least the endpoint device trajectories;
assigning the plurality of endpoint devices to a multi-user group based upon the detecting of the correspondence of the plurality of characteristics associated with the plurality of endpoint devices; and
transmitting via a multi-user multiple input-multiple output shared channel respective data streams to the plurality of endpoint devices in the multi-user group.

13. The non-transitory computer-readable medium of claim 12, wherein the endpoint device trajectories comprise directions of movement of the plurality of endpoint devices.

14. The non-transitory computer-readable medium of claim 13, wherein the endpoint device trajectories further comprise speeds of movement of the plurality of endpoint devices.

15. The non-transitory computer-readable medium of claim 12, wherein the plurality of characteristics further includes radio environment characteristics.

16. The non-transitory computer-readable medium of claim 15, wherein the detecting of the correspondence of the plurality of characteristics includes detecting that respective sets of characteristics of different endpoint devices of the plurality of endpoint devices have a similarity metric that meets a threshold.

17. The non-transitory computer-readable medium of claim 12, wherein the detecting of the correspondence of the plurality of characteristics is via a machine learning model that is configured to process sets of characteristics of a set of endpoint devices including the plurality of endpoint devices and to output the assigning of the plurality of endpoint devices to the multi-user group.

18. The non-transitory computer-readable medium of claim 12, wherein the endpoint device trajectories comprise predicted trajectories of the plurality of endpoint devices.

19. The non-transitory computer-readable medium of claim 12, wherein the operations further comprise:
detecting that an endpoint device trajectory of at least a first endpoint device of the plurality of endpoint devices diverges from endpoint device trajectories of other endpoint devices of the plurality of endpoint devices; and
removing the at least the first endpoint device from the multi-user group.

20. An apparatus comprising:
a processing system including at least one processor; and
a non-transitory computer-readable medium storing instructions which, when executed by the processing system when deployed in a wireless network, cause the processing system to perform operations, the operations comprising:
tracking a plurality of characteristics associated with a plurality of endpoint devices in a coverage area of the wireless network, wherein the plurality of characteristics includes endpoint device trajectories for the plurality of endpoint devices;
detecting a correspondence of the plurality of characteristics associated with the plurality of endpoint devices, wherein the detecting of the correspondence of the plurality of characteristics is based upon at least the endpoint device trajectories;
assigning the plurality of endpoint devices to a multi-user group based upon the detecting of the correspondence of the plurality of characteristics associated with the plurality of endpoint devices; and
transmitting via a multi-user multiple input-multiple output shared channel respective data streams to the plurality of endpoint devices in the multi-user group.
